(19) United States
(12) Patent Application Publication
(10) Pub. No.: US 2025/0284445 A1
(43) Pub. Date: Sep. 11, 2025

(54) VEHICLE DISPLAY CONTROL DEVICE AND VEHICLE DISPLAY CONTROL METHOD

(71) Applicant: TOYOTA JIDOSHA KABUSHIKI KAISHA, Toyota-shi (JP)

(72) Inventor: Miki TSUJINO, Ichinomiya-shi (JP)

(73) Assignee: TOYOTA JIDOSHA KABUSHIKI KAISHA, Toyota-shi (JP)

(21) Appl. No.: 19/014,399

(22) Filed: Jan. 9, 2025

(30) Foreign Application Priority Data
Mar. 7, 2024 (JP) 2024-035174

(51) Int. Cl. G06F 3/14; B60Q 9/00

(52) U.S. Cl. CPC G06F 3/1423; B60Q 9/00

(57) ABSTRACT

A vehicle display control device that displays a first image, which shows a peripheral situation of a host vehicle supposing viewing from a virtual viewpoint, at a display provided at a periphery of a driver's seat of the host vehicle; and at a time at which a drive assist function is operating, displays a second image, which shows a situation at a place that is a target of drive assist, at a position of the display, the position corresponding to the place.

### CROSS-REFERENCE TO RELATED APPLICATION

This application is based on and claims priority under 35 USC 119 from Japanese Patent Application No. 2024-035174 filed on Mar. 7, 2024, the disclosure of which is incorporated by reference herein.

### BACKGROUND

### Technical Field

The present disclosure relates to a vehicle display control device and a vehicle display control method.

### Related Art

Japanese Patent No. 6825709 discloses acquiring information of a periphery of a host vehicle, and by using the acquired information of the periphery of the host vehicle, generating a virtual image showing the periphery of the host vehicle as if the host vehicle was viewed from above. Before an automatic lane change is effected, when consideration as to whether or not to effect the automatic lane change starts, the display region of the periphery of the host vehicle in the virtual image is broadened as compared with before the start of consideration.

In accordance with the technique disclosed in Japanese Patent No. 6825709, a virtual image showing the periphery of the host vehicle is generated, and the generated virtual image can be displayed in a display region provided at the periphery of the driver's seat. On the other hand, vehicles equipped with drive assist functions such as a lane departure alert function are known, but information of the place that is the target of the drive assist is not reflected in the virtual image at the time when such a drive assist function operates. Therefore, there are cases in which it is difficult for the passenger to know, even if they look at the virtual image, what type of situation the place that is the target of the drive assist is in when such a drive assist function operates.

### SUMMARY

An aspect of the present disclosure is a vehicle display control device that includes: a memory; and a processor coupled with the memory, the processor being configured to: display a first image, which shows a peripheral situation of a host vehicle supposing viewing from a virtual viewpoint, at a display provided at a periphery of a driver's seat of the host vehicle; and at a time at which a drive assist function is operating, display a second image, which shows a situation at a place that is a target of drive assist, at a position of the display, the position corresponding to the place.

### BRIEF DESCRIPTION OF THE DRAWINGS

FIG. 1 is a schematic drawing illustrating a portion of the vehicle cabin interior of a vehicle that includes a vehicle display control device relating to an embodiment;

FIG. 2 is a drawing illustrating an example of a display region of a first display portion relating to the embodiment;

FIG. 3 is a block drawing illustrating an example of hardware structures of the vehicle display control device relating to the embodiment;

FIG. 4 is a block drawing illustrating an example of functional structures of the vehicle display control device relating to the embodiment;

FIG. 5 is a drawing illustrating an example of a first virtual viewpoint through a third virtual viewpoint relating to the embodiment;

FIG. 6 is a drawing illustrating an example of a first image showing the peripheral situation of a vehicle, which first image is displayed in the display region;

FIG. 7 is a drawing illustrating an example of the first image and a second image that are displayed in the display region;

FIG. 8A is a drawing illustrating a case in which the extent of departure is small, in a drawing showing an example of a displayed form in which the size of the second image is gradually increased in accordance with the extent of departure;

FIG. 8B is a drawing illustrating a case in which the extent of departure is medium, in a drawing showing an example of a displayed form in which the size of the second image is gradually increased in accordance with the extent of departure;

FIG. 8C is a drawing illustrating a case in which the extent of departure is large, in a drawing showing an example of a displayed form in which the size of the second image is gradually increased in accordance with the extent of departure;

FIG. 9A is an enlarged view of the second image illustrated in FIG. 8A;

FIG. 9B is an enlarged view of the second image illustrated in FIG. 8B;

FIG. 9C is an enlarged view of the second image illustrated in FIG. 8C; and

FIG. 10 is a flowchart illustrating an example of the flow of processing in accordance with a vehicle display control program relating to the embodiment.

### DETAILED DESCRIPTION

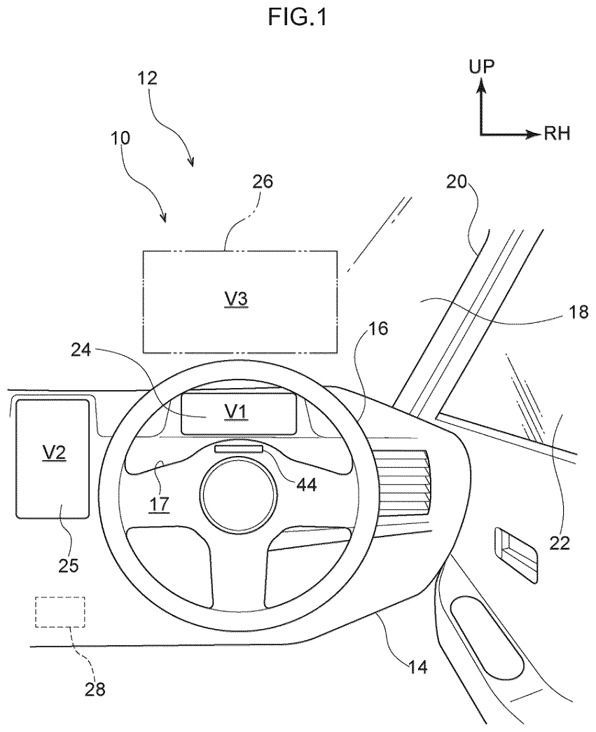

A vehicle display control system 10 equipped with a vehicle display control device 28 relating to an embodiment is described hereinafter with reference to the drawings. Note that arrow UP that is shown in FIG. 1 indicates the upper side in the vehicle vertical direction, and arrow RH indicates the right side in the vehicle transverse direction. The vertical direction and the left-right direction in the following explanation mean the vertical of the vehicle vertical direction and the left and right of the vehicle transverse direction, respectively.

FIG. 1 is a schematic drawing illustrating a portion of the vehicle cabin interior of a vehicle 12 that includes the vehicle display control device 28 relating to the present embodiment. The example of FIG. 1 illustrates a state in which the front portion of the vehicle cabin interior of the vehicle 12 is seen from the vehicle rear side.

As illustrated in FIG. 1, an instrument panel 14 is provided at the front portion of the vehicle cabin interior of the vehicle 12. The instrument panel 14 extends in the vehicle transverse direction, and a steering wheel 16 is provided at the vehicle right side of the instrument panel 14. Namely, in the present embodiment, the vehicle 12 is, as an example, a right-hand-drive vehicle in which the steering wheel 16 is provided at the right side, and the driver's seat is provided at the vehicle right side. Note that the present disclosure is not limited to this and may be applied to vehicles in which the driver's seat is set at the vehicle left side.

A windshield glass 18 is provided at the front end portion of the instrument panel 14. The windshield glass 18 extends in the vehicle vertical direction and the vehicle transverse direction, and separates the interior of the vehicle cabin and the exterior of the vehicle cabin.

A front pillar 20 at the vehicle right side is fixed to the vehicle right side end portion of the windshield glass 18. The front pillar 20 extends in the vehicle vertical direction, and the windshield glass 18 is fixed to the vehicle transverse direction inner side end portion of this front pillar 20. Further, the front end portion of a front side glass 22 is fixed to the vehicle transverse direction outer side end portion of the front pillar 20. Note that the vehicle left side end portion of the windshield glass 18 is fixed to a front pillar that is at the vehicle left side.

Here, a first display portion 24 that has a display region V1 for images is provided at the instrument panel 14. The first display portion 24 is structured at the vehicle right side of the instrument panel 14 by a meter display that is provided at the vehicle front side of the driver's seat. The first display portion 24 is connected to the various meter instruments installed in the vehicle 12, and is provided at a position that is within the field of view in the state in which the sightline of the passenger (hereinafter, also called “driver”) is directed toward the vehicle front side. The display region V1 is a region that the driver who is in the driver's seat can see through an opening portion 17 of the steering wheel 16.

A second display portion 25 that has a display region V2 for images is provided at the instrument panel 14. The second display portion 25 is structured by a center display disposed at the central portion in the vehicle transverse direction of the instrument panel 14.

A third display portion 26 that has a display region V3 for images is provided at the windshield glass 18. The third display portion 26 is set at the vehicle upper side of the first display portion 24 and is structured by a projected plane that is projected by a head-up display device serving as the display device. Specifically, the head-up display device that can project images is provided at the vehicle front side of the instrument panel 14, and images are projected from the head-up display device onto the third display portion 26 of the windshield glass 18. Namely, the third display portion 26 is a portion of the windshield glass 18 which portion is the projected plane of the head-up display device.

A sightline detecting sensor 44 is provided at the steering wheel 16. The sightline detecting sensor 44 is disposed so as to face the face of the driver seated in the driver's seat.

Here, the vehicle display control device 28 that structures the vehicle display control system 10 is provided at the vehicle 12. The vehicle display control device 28 of the present embodiment is, for example, an ECU (Electronic Control Unit) that carries out various types of control. The vehicle display control device 28 relating to the present embodiment is structured so as to display a first image, which shows the peripheral situation of the host (own) vehicle supposing viewing from a virtual viewpoint, in at least one display region among the display region V1, the display region V2 and the display region V3 that are at the periphery of the driver's seat.

Hereinafter, as an example, description is given of a case in which a first image and a second image (described later) relating to the present embodiment are displayed on the first display portion 24 of the vehicle 12. Note that the first image and the second image relating to the present embodiment are not limited to being displayed on the first display portion 24, and may be displayed on the second display portion 25 or the third display portion 26.

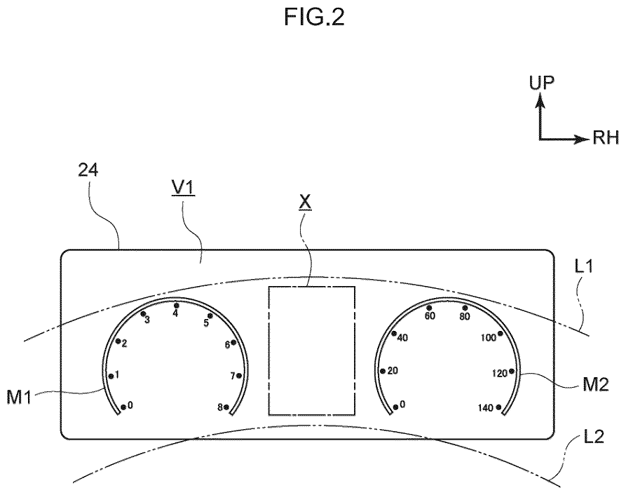

FIG. 2 is a drawing illustrating an example of the display region V1 of the first display portion 24 relating to the present embodiment.

As illustrated in FIG. 2, the vehicle display control device 28 displays images showing the peripheral situation of the vehicle 12, in region X that is a partial region of the display region V1. As described above, region X is a region that the driver in the driver's seat can see through the opening portion 17 of the steering wheel 16. Specifically, as illustrated in FIG. 2, the center of the region that the driver can see from between an upper edge ridgeline L1 and a lower edge ridgeline L2 of the opening portion 17 of the steering wheel 16 is region X. Meter displays M1, M2 showing meters of measuring instruments of the vehicle 12 are displayed at the left and the right of region X.

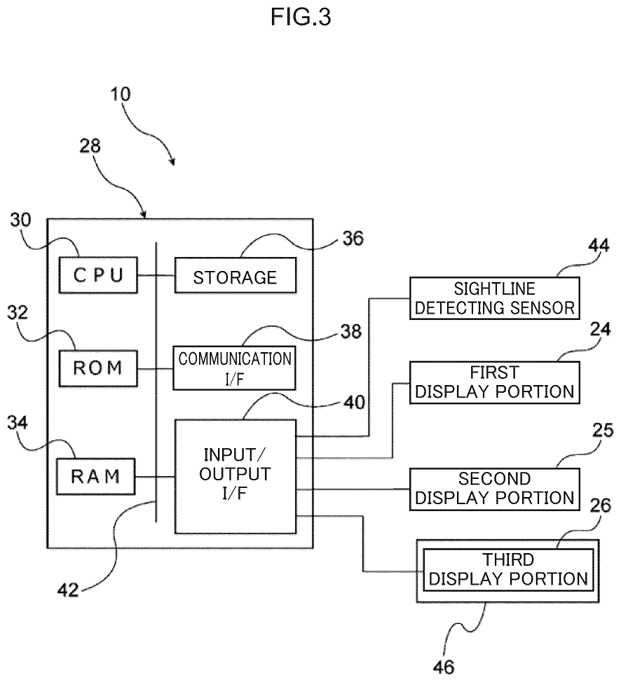

FIG. 3 is a block drawing illustrating an example of hardware structures of the vehicle display control device 28 relating to the present embodiment.

As illustrated in FIG. 3, the vehicle display control device 28 is structured to include a CPU (Central Processing Unit: processor) 30, a ROM (Read Only Memory) 32, a RAM (Random Access Memory) 34, a storage 36, a communication interface (communication I/F) 38, and an input/output interface (input/output I/F) 40. These respective structures are connected so as to be able to communicate with one another via internal bus 42.

The CPU 30 that is an example of a hardware processor executes various programs, controls respective sections, and functions as a peripheral information acquiring section, a function information acquiring section and a display control section that are described later. Namely, the CPU 30 loads programs from the ROM 32 or the storage 36, and executes the programs by using the RAM 34 as a workspace. Further, the CPU 30 carries out control of the above-described respective structures, and various types of computing processings, in accordance with programs recorded in the ROM 32 or the storage 36.

The ROM 32 that is an example of the memory stores various programs and various data. The RAM 34 that is an example of the memory temporarily stores programs and data as a workspace. The storage 36 that is an example of the memory is structured by an HDD (Hard Disk Drive) or an SSD (Solid State Drive), and is a non-transitory storage medium that stores various programs, including the operating system, and various data. A vehicle display control program, for carrying out a vehicle display control processing relating to the present embodiment, is stored in the ROM 32 or the storage 36.

The communication interface 38 is an interface for the vehicle display control device 28 to communicate with servers and other devices, and standards such as, for example, CAN (Controller Area Network), Ethernet®, LTE (Long Term Evolution), FDDI (Fiber Distributed Data Interface), or Wi-Fi® are used thereat.

The sightline detecting sensor 44, the first display portion 24, the second display portion 25 and a head-up display device 46 are connected to the input/output interface 40. Further, images are projected by the head-up display device 46 onto the third display portion 26.

The sightline detecting sensor 44 is provided at the steering wheel 16, and is disposed so as to face the face of the driver seated in the driver's seat. By recognizing the eyes of a passenger, the sightline detecting sensor 44 detects the sightline direction of the passenger by using the principles of a corneal reflection method or a scleral reflection method or the like. Note that the sightline detecting sensor 44 may be provided at the instrument panel 14.

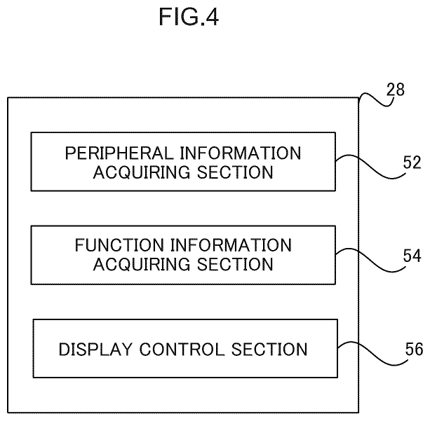

The vehicle display control device 28 realizes various functions by using the above-described hardware resources. The functional structures realized by the vehicle display control device 28 are described with reference to FIG. 4.

FIG. 4 is a block drawing illustrating an example of functional structures of the vehicle display control device 28 relating to the present embodiment.

As illustrated in FIG. 4, the vehicle display control device 28 is structured to include, as the functional structures thereof, a peripheral information acquiring section 52, a function information acquiring section 54 and a display control section 56. Note that these respective functional structures are realized by the CPU 30 reading-out and executing the vehicle display control program stored in the ROM 32 or the storage 36.

The peripheral information acquiring section 52 acquires peripheral information expressing the situation at the periphery of the vehicle 12 (the host vehicle). Specifically, plural sensors that can detect the peripheral situation are provided at the vehicle 12, and information detected by these plural sensors is acquired as peripheral information.

Map information of the periphery of the vehicle 12 also is included in the peripheral information. A GPS receiver for acquiring the current position is provided at the vehicle 12. The peripheral information acquiring section 52 refers to the position information of the vehicle and to map data that is stored in an external server or the storage 36, and acquires map information of the periphery of the vehicle 12.

The function information acquiring section 54 acquires information relating to the drive assist function that is operating. The vehicle 12 is provided with drive assist functions. At least one function among, for example, a lane departure warning function, a road sign recognizing function, a lane change assist function, a blind spot monitoring function, an alighting assist function, a vehicle approach warning function and an obstacle approach sensing function are included in what is called the “drive assist functions” here.

The lane departure warning function is a function also called Lane Departure Alert (hereinafter called LDA) for example. When it is judged that there is the possibility that the vehicle 12 is departing from its traveling lane, LDA gives a warning urging the driver to carry out a departure avoidance operation, by a buzzer warning, a display or the like. In LDA, the traveling state of the vehicle 12 is monitored by using cameras, radar and the like provided at the vehicle 12, and it is judged whether or not there is the possibility that the vehicle 12 is departing from the traveling lane.

The road sign recognizing function is a function also called Road Sign Assist (hereinafter called RSA) for example. RSA displays, in a display region at the periphery of the driver's seat, road signs such as “speed limit”, “do not pass”, and “stop”. If it is judged that the vehicle 12 is not obeying road signs such as “speed limit” and “do not enter” or a “red light”, RSA notifies the driver by a buzzer warning, a display or the like that they are not obeying the road sign or the red light. In RSA, road signs and red lights are recognized by using the cameras and the like provided at the vehicle 12, and it is judged whether or not the vehicle 12 is obeying a road sign or a red light.

The lane change assist function is a function also called Lane Change Assist (hereinafter called “LCA”) for example. LCA operates in accordance with operation of a turn signal by the driver, and monitors vehicles at the periphery while the vehicle 12 is changing lanes, and carries out steering assist such that the vehicle 12 does not collide with peripheral vehicles. In LCA, the peripheral region of the vehicle 12 is monitored by using cameras, radar and the like provided at the vehicle 12, and vehicles traveling in the lane into which the vehicle 12 is changing are recognized.

The blind spot monitoring function is a function also called Blind Spot Monitor (hereinafter called “BSM”) for example. If another vehicle (including motorcycles, bicycles and the like) that exists in a blind spot such as at the rear of the vehicle 12 is recognized, the BSM lights or flashes a door mirror indicator of the vehicle 12, or notifies the driver by a buzzer warning or the like. In BSM, the blind spots of the vehicle 12 are monitored by using sensors and the like provided at the vehicle 12, and other vehicles existing in the blind spots are recognized.

The alighting assist function is a function also called Safe Exit Assist (hereinafter called “SEA”) for example. If a bicycle or a pedestrian or the like, who is approaching the vehicle 12 from the rear at the time when the driver is exiting the vehicle 12, is recognized, SEA lights or flashes a door mirror indicator of the vehicle 12, or notifies the driver by a buzzer warning or the like. In SEA, the rear of the vehicle 12 is monitored by using sensors and the like provided at the vehicle 12, and bicycles and pedestrians and the like that are approaching from the rear are recognized.

The vehicle approach warning function is a function also called the Pre-Collision System (hereinafter called “PCS”) for example. PCS recognizes the preceding vehicle of the vehicle 12, and if it is judged that the distance between the vehicles is too close, i.e., that the possibility of a collision is high, PCS informs the driver by a buzzer warning or a display or the like. Note that PCS is not limited to vehicles, and motorcycles, bicycles, pedestrians and the like also are targets thereof. In PCS, the inter-vehicle distance between the vehicle 12 and the preceding vehicle is measured by using cameras, radar and the like provided at the vehicle 12, and, on the basis of the measured inter-vehicle distance, it is judged whether or not the possibility of a collision is high.

The obstacle approach sensing function is a function also called Intelligent Clearance Sonar (hereinafter called “ICS”) for example. For example, at the time when the vehicle is traveling at a low speed such as during parking, if the distance between the vehicle 12 and an obstacle is close, i.e., if the possibility of the vehicle 12 hitting an obstacle is high, ICS notifies the driver by a buzzer warning, a display or the like. In ICS, the distance to an obstacle is measured by using sonar (also called a sensor) provided at the vehicle 12, and, on the basis of the measured distance, it is judged whether or not the possibility of hitting is high. Further, the obstacle approach sensing function may be a function that senses, for example, a motorcycle slipping past.

The display control section 56 displays the first image, which shows the peripheral situation of the host vehicle, in a display region provided at the periphery of the driver's seat of the host vehicle. Here, the “first image, which shows the peripheral situation of the host vehicle” is an image that supposes viewing from a virtual viewpoint. The “display region provided at a periphery of a driver's seat of the host vehicle” is, as described above, at least one display region among the display region V1, the display region V2 and the display region V3.

The virtual viewpoint is a viewpoint set in a virtual space. In the example of the present embodiment, the virtual viewpoint is set in a three-dimensional virtual space whose origin O is the position of the vehicle 12 (the host vehicle). This virtual viewpoint can be defined by the viewpoint coordinates and the viewpoint angle (orientation) in the virtual space.

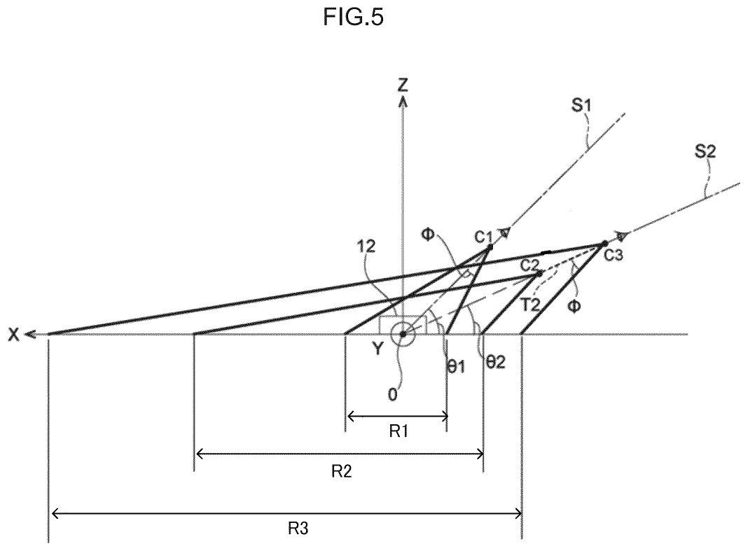

FIG. 5 is a drawing illustrating examples of a first virtual viewpoint C1 through a third virtual viewpoint C3 relating to the present embodiment.

As illustrated in FIG. 5, the virtual coordinates of virtual viewpoints C1 through C3 are three-dimensional coordinates with the vehicle longitudinal direction (advancing direction) of the vehicle 12 being the X-axis, the vehicle transverse direction being the Y-axis and the vehicle vertical direction being the Z-axis. The viewpoint angle can be expressed as a set of the rotation angles (roll, pitch, yaw angles) around these respective axes.

Accordingly, the display control section 56 supposes viewing of the periphery of the vehicle 12 at a specific viewpoint angle from specific viewpoint coordinates in the virtual space, and generates an image showing the peripheral situation of the vehicle 12, and displays the image in a display region.

The first virtual viewpoint C1 is a viewpoint of viewing the vehicle 12 from a high position at an obliquely rear side. As an example, the viewpoint angle of the first virtual viewpoint C1 coincides with the direction of segment S1 that passes through the origin O and the viewpoint coordinates of the first virtual viewpoint C1, and has the largest rotation angle around the Y-axis (pitch angle) θ1. The display control section 56 generates an image of range R1 that can be seen at predetermined image angle ϕ from the first virtual viewpoint C1, and displays the image in a display region as an image showing the peripheral situation of the vehicle 12.

A second virtual viewpoint C2 is a viewpoint of viewing from further rearward than the first virtual viewpoint C1, and is a viewpoint of viewing from a position lower than the first virtual viewpoint C1. As an example, the viewpoint angle of the second virtual viewpoint C2 coincides with the direction of segment S2 that passes through the origin O and the viewpoint coordinates of the second virtual viewpoint C2, and the rotation angle around the Y-axis (the pitch angle) θ2 is smaller than the rotation angle θ1 of the first virtual viewpoint C1. Therefore, the second virtual viewpoint C2 is a viewpoint that is oriented more upwardly than the first virtual viewpoint C1. The display control section 56 generates an image of range R2 that can be seen at the predetermined image angle ϕ from the second virtual viewpoint C2, and displays the image in a display region as an image showing the peripheral situation of the vehicle 12.

The third virtual viewpoint C3 is a viewpoint of viewing from further rearward than the first virtual viewpoint C1 and the second virtual viewpoint C2, and is a viewpoint of viewing from a position that is lower than the first virtual viewpoint C1 and higher than the second virtual viewpoint C2. As an example, the viewpoint angle of the third virtual viewpoint C3 coincides with that of the second virtual viewpoint C2. The display control section 56 generates an image of range R3 that can be seen at the predetermined image angle ¢ from the third virtual viewpoint C3, and displays the image in a display region as an image showing the peripheral situation of the vehicle 12.

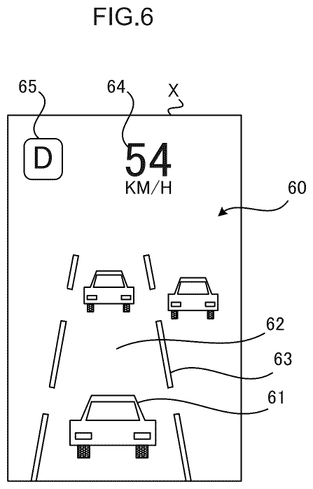

The display control section 56 relating to the present embodiment sets any virtual viewpoint among the first virtual viewpoint C1 through the third virtual viewpoint C3, and as illustrated in FIG. 6 for example, displays first image 60, which shows the peripheral situation of the vehicle 12, in region X that is a partial region of the display region V1.

FIG. 6 is a drawing illustrating an example of the first image 60 that shows the peripheral situation of the vehicle 12 and is displayed in region X.

As illustrated in FIG. 6, the display control section 56 displays, as the first image 60, a lane image 62 showing the traveling lane of the vehicle 12 and a white line image 63 showing the white lines that demarcate the traveling lane, at the periphery of a host vehicle image 61 showing the vehicle 12. Further, an image 64 showing the traveling speed of the vehicle 12 and an image 65 showing the shift position of the vehicle 12 are displayed above the lance image 62.

At the time when a drive assist function is operating, the display control section 56 relating to the present embodiment displays a second image showing the situation at the place that is the target of the drive assist, at the position of the display region which position corresponds to that place. Namely, the drive assist function and the display of the display region are linked, and the driver can understand the situation at the place that is the target of drive assist merely by glancing at the display of the display region.

Here, the second image may be a captured image, or may be a schematic image. A captured image is an image in which the situation at the place that is the target of drive assist is imaged by cameras provided at the vehicle 12. A schematic image is an image that, differently from a captured image, schematically shows the situation at the place that is the target of drive assist. A layer for displaying the second image is added to region X, and the layer that displays the second image is different than the layer that displays the first image 60. Due thereto, the driver can understand in detail the situation at the place that is the target of drive assist.

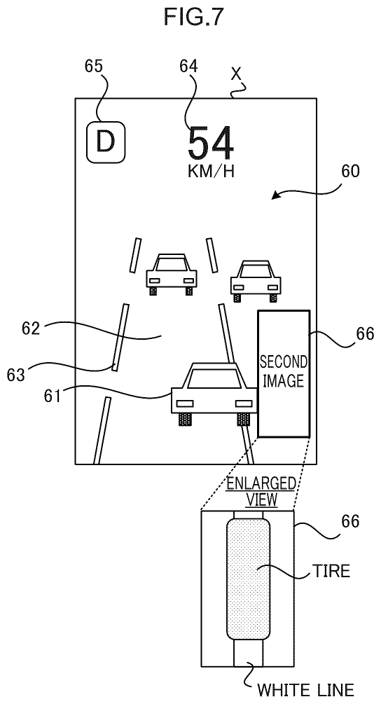

A second image 66, which is displayed in region X of the display region V1 that is an example of the display region at the time when LDA serving as an example of a drive assist function is operating, is described concretely hereinafter with reference to FIG. 7. In the case of LDA, the place that is the object of the drive assist is the white lines positioned at both sides or at one side of the vehicle 12 that is traveling.

FIG. 7 is a drawing illustrating an example of the first image 60 and the second image 66 that are displayed in region X.

As illustrated in FIG. 7, when LDA is operating, the display control section 56 displays the second image 66 at a position of region X which position corresponds to a place including the white lines that are the target of LDA. The second image 66 is an image showing the situation at a place that includes the white lines that are the target. The second image 66 shows a state in which a portion of a tire of the vehicle 12 has crossed the white lines and has departed from the traveling lane. By looking at the second image 66 of region X, the driver can understand the extent to which the vehicle is departing from the traveling lane. Note that, although the second image 66 is shown as a schematic image in the example of FIG. 7, a captured image in which the white lines and the situation of the tire are actually imaged may be displayed.

Further, the display control section 56 may gradually change the displayed form of the second image 66 as the extent to which the vehicle 12 departs from the traveling lane increases. Here, the extent of the departure can be expressed by the distance over which the vehicle 12 is departing from the traveling lane (hereinafter called “departure distance”). The departure distance can be derived from the relationship of correspondence between the traveling lane and the position of the vehicle 12 by, for example, recognizing the traveling lane of the vehicle 12 and specifying the position of the vehicle 12. The magnitude of the extent of the departure can be judged by a threshold value judgement of the departure distance.

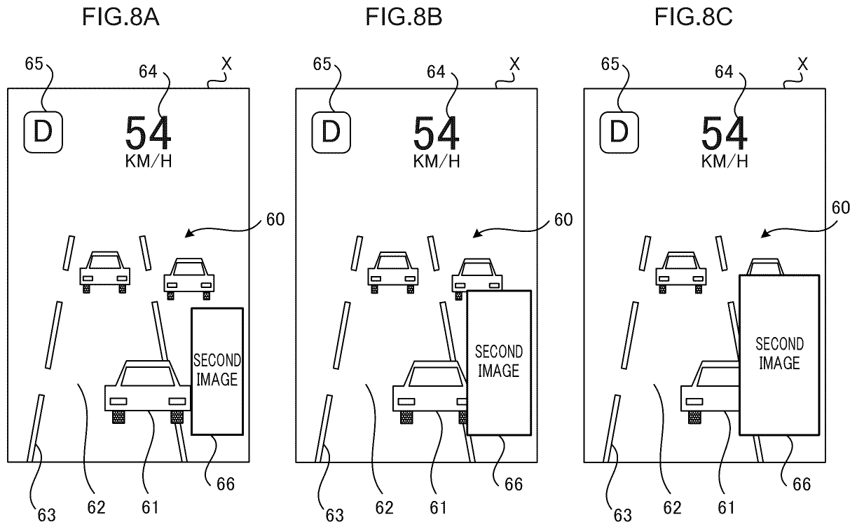

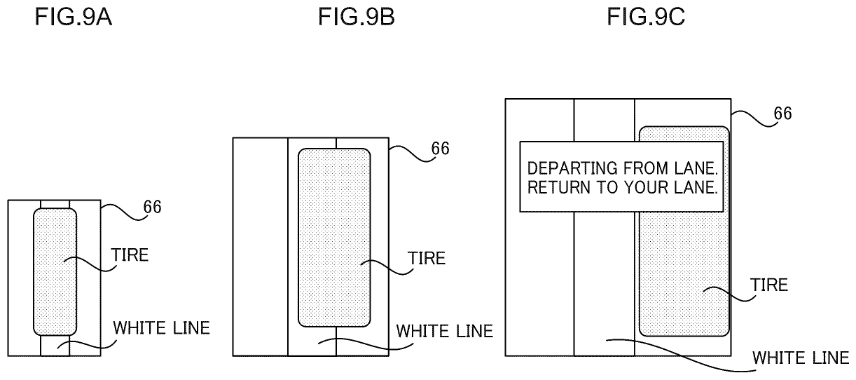

Further, the changing of the displayed form of the second image 66 may be a gradual increase in the size of the second image 66, as illustrated as examples in FIG. 8A through FIG. 8C and FIG. 9A through FIG. 9C. At this time, if the size of the second image 66 is greater than or equal to a threshold value, a warning display may be carried out. What is called “threshold value” here is an appropriate value set on the basis of past knowledge or results of testing.

FIG. 8A through FIG. 8C are drawings illustrating examples of displayed forms in which the size of the second image 66 is gradually increased in accordance with the extent of the departure. FIG. 9A through FIG. 9C are enlarged views of the second images 66 illustrated in FIG. 8A through FIG. 8C.

As illustrated in FIG. 8A and FIG. 9A, if the extent of the departure is small, the display control section 56 displays the second image 66 that is of a standard size. Next, as illustrated in FIG. 8B and FIG. 9B, if the extent of the departure is medium, the display control section 56 displays the second image 66 that is of a size larger than the size of the second image 66 displayed in a case in which the extent of the departure is small. Next, as illustrated in FIG. 8C and FIG. 9C, if the extent of the departure is large, the display control section 56 displays the second image 66 that is of a size larger than the size of the second image 66 displayed in a case in which the extent of the departure is medium. Note that, in the examples illustrated in FIG. 8A through FIG. 8C and in FIG. 9A through FIG. 9C, the image sizes are changed in three stages, but the number of stages is not particularly limited provided that it is two or more stages.

Here, if the size of the second image 66 is greater than or equal to a threshold value, it is preferable that the display control section 56 carry out warning display as described above. In the example of FIG. 8C and FIG. 9C, in a case in which the extent of the departure is large, the size of the second image 66 is greater than or equal to a threshold value, and therefore, a warning text is displayed As an example, as illustrated in FIG. 9C, “Departing from lane. Return to your lane.” is displayed as this warning text.

Note that the above shows a displayed form in which the size of the second image 66 is gradually increased in accordance with the extent of the departure, but the present disclosure is not limited to this. The changing of the displayed form of the second image 66 may be a gradual changing of the color of the image (e.g., the color is gradually made deeper or is gradually made more vivid), or may be a gradual changing of the shape of the image (e.g., the shape may be changed from rectangular to oval, or from oval to rectangular). It suffices for the changing of the displayed form of the second image 66 to be a change that is such that the driver can recognize the change in the displayed form.

Further, although the above describes the lane departure warning function (LDA) as an example of the drive assist function, the present disclosure is not limited to this. As described above, the present disclosure can be similarly applied to other drive assist functions such as, for example, a road sign recognizing function (RSA), a lane change assist function (LCA), a blind spot monitoring function (BSM), an alighting assist function (SEA), a vehicle approach warning function (PCS) and an obstacle approach sensing function (ICS).

In the case of a road sign recognizing function (RSA), the second image 66 is an image showing the situation at a place that includes the road sign that is the target. In the case of a lane change assist function (LCA), the second image 66 is an image showing the situation at a place that includes the lane that the vehicle is to change into. In the case of a blind spot monitoring function (BSM), the second image 66 is an image showing the situation at a place that is a blind spot. In the case of an alighting assist function (SEA), the second image 66 is an image showing the situation at a place that is a blind spot. In the case of a vehicle approach warning function (PCS), the second image 66 is an image showing the situation at a place that includes an approaching vehicle. In the case of an obstacle approach sensing function (ICS), the second image 66 is an image showing the situation at a place that includes an approaching obstacle.

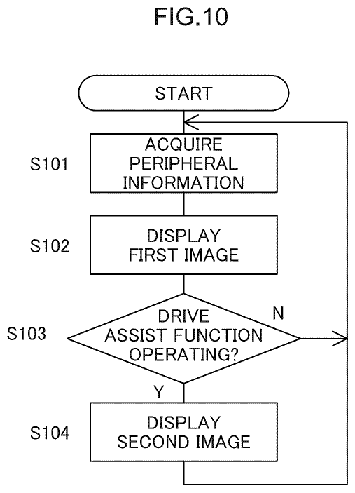

Operation of the vehicle display control device 28 relating to the present embodiment is described next with reference to FIG. 10.

FIG. 10 is a flowchart illustrating an example of the flow of processing in accordance with the vehicle display control program relating to the present embodiment.

First, when the vehicle display control device 28 is instructed to execute the vehicle display control processing, the vehicle display control program is started-up by the CPU 30, and the following steps are executed.

In step S101 of FIG. 10, the CPU 30 acquires peripheral information expressing the peripheral situation of the vehicle 12. Specifically, as described above, plural sensors that can detect the peripheral situation are provided at the vehicle 12, and the information detected by these plural sensors is acquired as the peripheral information.

In step S102, as an example, as illustrated in above-described FIG. 6, the CPU 30 generates the first image 60 showing the peripheral situation of the vehicle 12 from the peripheral information acquired in step S101, and displays the generated first image 60 in region X.

In step S103, the CPU 30 judges whether or not a drive assist function is operating. If the CPU 30 judges that a drive assist function is operating (an affirmative judgment), the CPU 30 moves on to step S104. If the CPU 30 judges that a drive assist function is not operating (a negative judgment), the CPU 30 returns to step S101 and repeats processing. At least one of, for example, a lane departure warning function (LDA), a sign recognizing function (RSA), a lane change assist function (LCA), a blind spot monitoring function (BSM), an alighting assist function (SEA), a vehicle approach warning function (PCS) and an obstacle approach sensing function (ICS) is included as the drive assist function as described above.

In step S104, as an example, as illustrated in above-described FIG. 7, the CPU 30 displays the second image 66, which shows the situation at the place that is the target of the drive assist (e.g., a place that includes the white lines that are the target), at a position of region X which position corresponds to that place, and returns to step S101 and repeats processing. Note that, in the case of a lane departure warning function (LDA), the second image 66 is displayed in a manner corresponding to the extent of the departure.

In this way, in accordance with the present embodiment, at the time when a drive assist function is operating, the situation at the place that is the target of the drive assist can be displayed in a manner that is easy for a passenger to understand. For example, at the time when a lane departure warning function (LDA) is operating, the driver can understand at a glance to what extent the host vehicle is departing from its traveling lane. By making it easy for a passenger to understand the situation at the place that is the target of drive assist, mistakes in driving operations by the passenger can be reduced, and the driving operation experience for the passenger can be improved.

Note that the vehicle display control processing, which is executed by the CPU 30 loading software (a program) in the above-described embodiment, may be executed by any of various types of processors other than a CPU. Examples of processors in this case include PLDs (Programmable Logic Devices) whose circuit structure can be changed after production such as FPGAs (Field-Programmable Gate Arrays), and dedicated electrical circuits that are processors having circuit structures that are designed for the sole purpose of executing specific processings such as ASICs (Application Specific Integrated Circuits). Further, the vehicle display control processing may be executed by one of these various types of processors, or may be executed by a combination of two or more of the same type or different types of processors (e.g., plural FPGAs, or a combination of a CPU and an FPGA). Further, the hardware structures of these various types of processors are, more specifically, electrical circuits that combine circuit elements such as semiconductor elements.

Further, the above embodiment describes a form in which the vehicle display control program is stored in advance (is installed) in the ROM 32 or the storage 36, but the present disclosure is not limited to this. The vehicle display control program may be provided in a form of being stored on a recording medium such as a CD-ROM (Compact Disk Read Only Memory), a DVD-ROM (Digital Versatile Disk Read Only Memory), or a USB (Universal Serial Bus) memory. Further, the vehicle display control program may be in a form of being downloaded over a network from an external device. The vehicle display control program may be a program product.

In addition, the structure of the vehicle display control device described in the above embodiment is an example, and may be changed in accordance with the situation and within a scope that does not depart from the gist thereof.

Further, the flow of the processing of the program described in the above embodiment also is an example, and unnecessary steps may be deleted therefrom, new steps may be added thereto, or the order of processings may be rearranged within a scope that does not depart from the gist thereof.

An object of the present disclosure is to provide a vehicle display control device and a vehicle display control method that, when a drive assist function is operating, can display the situation at the place that is the target of the drive assist in a manner that is easy for a passenger to understand.

A first aspect of the present disclosure is a vehicle display control device that includes: a memory; and a processor coupled with the memory, the processor being configured to: display a first image, which shows a peripheral situation of a host vehicle supposing viewing from a virtual viewpoint, at a display provided at a periphery of a driver's seat of the host vehicle; and at a time at which a drive assist function is operating, display a second image, which shows a situation at a place that is a target of drive assist, at a position of the display, the position corresponding to the place.

In the vehicle display control device relating to the first aspect, at the time when a drive assist function is operating, the situation at the place that is the target of drive assist can be displayed in a manner that is easy for the passenger to understand.

A second aspect is the vehicle display control device of the first aspect, wherein the second image is a captured image in which the situation at the place is imaged, or is a schematic image that schematically shows the situation at the place.

In the vehicle display control device relating to the second aspect, the situation at the place that is the target of drive assist can be understood more concretely.

A third aspect is the vehicle display control device of the first aspect, wherein a layer that displays the second image is different than a layer that displays the first image.

In the vehicle display control device relating to the third aspect, displaying of the second image can be carried out independently of the first image.

A fourth aspect is the vehicle display control device of the first aspect, wherein: the drive assist function is a lane departure warning function, and the processor is configured to change gradually a displayed form of the second image as an extent to which the host vehicle departs from a travel lane increases.

In the vehicle display control device relating to the fourth aspect, the extent of the departure from the traveling lane can be understood more easily.

A fifth aspect is the vehicle display control device of the fourth aspect, wherein changing of the displayed form of the second image is a gradual increase of a size of the second image.

In the vehicle display control device relating to the fifth aspect, the extent of the departure from the traveling lane can be understood at a glance.

A sixth aspect is the vehicle display control device of the fifth aspect, wherein the processor is configured to carry out warning display in a case in which the size of the second image is greater than or equal to a threshold value.

In the vehicle display control device relating to the sixth aspect, the passenger can be warned that the host vehicle is departing from the traveling lane.

A seventh aspect is the vehicle display control device of the first aspect, wherein the drive assist function includes at least one of a lane departure warning function, a road sign recognizing function, a lane change assist function, a blind spot monitoring function, an alighting assist function, a vehicle approach warning function or an obstacle approach sensing function.

The vehicle display control device relating to the seventh aspect is not limited to a lane departure warning function, and can similarly be applied also to a road sign recognizing function, a lane change assist function, a blind spot monitoring function, an alighting assist function, a vehicle approach warning function and an obstacle approach sensing function.

An eighth aspect of the present disclosure is a vehicle display control method executing processing by a processor, the method including: displaying a first image, which shows a peripheral situation of a host vehicle supposing viewing from a virtual viewpoint, at a display provided at a periphery of a driver's seat of the host vehicle; and at a time at which a drive assist function is operating, displaying a second image, which shows a situation at a place that is a target of drive assist, at a position of the display, the position corresponding to the place.

A ninth aspect of the present disclosure is a non-transitory computer-readable recording medium storing a program that causes a computer to execute a vehicle display control process, the process including: displaying a first image, which shows a peripheral situation of a host vehicle supposing viewing from a virtual viewpoint, at a display provided at a periphery of a driver's seat of the host vehicle; and at a time at which a drive assist function is operating, displaying a second image, which shows a situation at a place that is a target of drive assist, at a position of the display, the position corresponding to the place.

As described above, in accordance with the present disclosure, at a time when a drive assist function is operating, the situation at the place that is the target of the drive assist can be displayed in a manner that is easy for the passenger to understand.

What is claimed is:

1. A vehicle display control device comprising:
a memory; and
a processor coupled with the memory, the processor being configured to:
display a first image, which shows a peripheral situation of a host vehicle supposing viewing from a virtual viewpoint, at a display provided at a periphery of a driver's seat of the host vehicle; and
at a time at which a drive assist function is operating, display a second image, which shows a situation at a place that is a target of drive assist, at a position of the display, the position corresponding to the place.

2. The vehicle display control device of claim 1, wherein the second image is a captured image in which the situation at the place is imaged, or is a schematic image that schematically shows the situation at the place.

3. The vehicle display control device of claim 1, wherein a layer that displays the second image is different than a layer that displays the first image.

4. The vehicle display control device of claim 1, wherein:
the drive assist function is a lane departure warning function, and
the processor is configured to change gradually a displayed form of the second image as an extent to which the host vehicle departs from a travel lane increases.

5. The vehicle display control device of claim 4, wherein changing of the displayed form of the second image is a gradual increase of a size of the second image.

6. The vehicle display control device of claim 5, wherein the processor is configured to carry out warning display in a case in which the size of the second image is greater than or equal to a threshold value.

7. The vehicle display control device of claim 1, wherein the drive assist function includes at least one of a lane departure warning function, a road sign recognizing function, a lane change assist function, a blind spot monitoring function, an alighting assist function, a vehicle approach warning function or an obstacle approach sensing function.

8. A vehicle display control method executing processing by a processor, the method comprising:
displaying a first image, which shows a peripheral situation of a host vehicle supposing viewing from a virtual viewpoint, at a display provided at a periphery of a driver's seat of the host vehicle; and
at a time at which a drive assist function is operating, displaying a second image, which shows a situation at a place that is a target of drive assist, at a position of the display, the position corresponding to the place.

9. A non-transitory computer-readable recording medium storing a program that causes a computer to execute a vehicle display control process, the process comprising:
displaying a first image, which shows a peripheral situation of a host vehicle supposing viewing from a virtual viewpoint, at a display provided at a periphery of a driver's seat of the host vehicle; and
at a time at which a drive assist function is operating, displaying a second image, which shows a situation at a place that is a target of drive assist, at a position of the display, the position corresponding to the place.
